(19) United States
(12) Patent Application Publication
(10) Pub. No.: US 2024/0072632 A1
(43) Pub. Date: Feb. 29, 2024

(54) SOFT SWITCHING POWER CONVERTER

(71) Applicant: Siemens Aktiengesellschaft, München (DE)

(72) Inventor: Abhijit Kadam, Thane (IN)

(21) Appl. No.: 18/234,532

(22) Filed: Aug. 16, 2023

(30) Foreign Application Priority Data
Aug. 31, 2022 (EP) 22193234.6

(51) Int. Cl. H02M 1/00; B60L 53/22; H02M 3/00; H02M 3/335

(52) U.S. Cl. CPC H02M 1/0058; B60L 53/22; H02M 3/01; H02M 3/33573; B60L 2210/10

(57) ABSTRACT

A power converter, a control unit, a charging device and a method for transferring power to an EV from a power grid are provided. The power converter includes an isolated DC-DC converter having a first stage converting a DC voltage into a high frequency AC voltage having an amplitude V1, an intermediary stage having a high frequency transformer, a resonant tank which outputs a resonant sinusoidal current scaled by the high frequency transformer, and a second stage, connected to a secondary winding of the high frequency transformer, including a power conversion switch, four diodes, and two or more capacitors, that selectively converts the high frequency AC voltage of amplitude V2 into a DC voltage of amplitude V2 or 2V2.

### CROSS-REFERENCE TO RELATED APPLICATIONS

This application claims priority to EP Application No. 22193234.6, having a filing date of Aug. 31, 2022, the entire contents of which are hereby incorporated by reference.

### FIELD OF TECHNOLOGY

The following relates to a power converter. More particularly, the following relates to a soft switching resonant power converter employable in DC fast charging of Electric Vehicles (EVs).

### BACKGROUND

EVs are being adopted worldwide as an alternative to the traditional internal combustion-based vehicles. Therefore, there arises a growing demand for the development of charging infrastructure for fast charging of these EVs. One of the methods for fast charging is a DC fast charger.

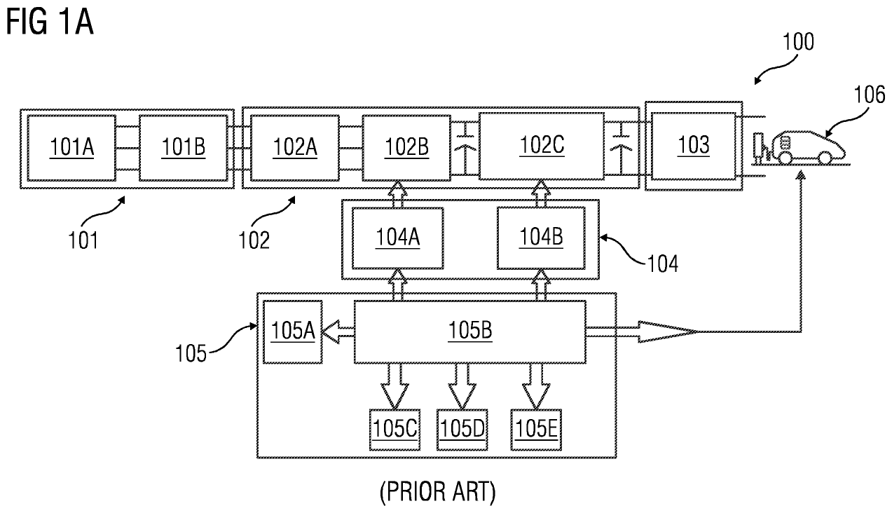

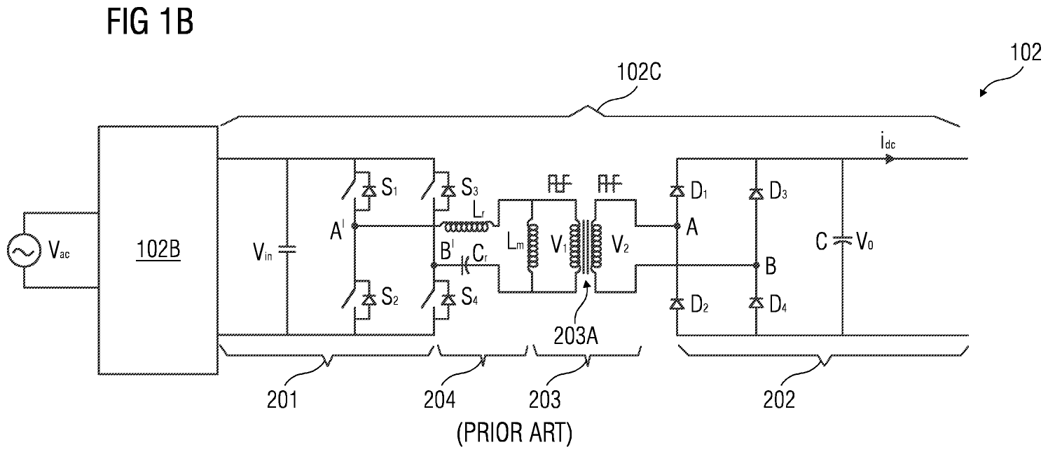

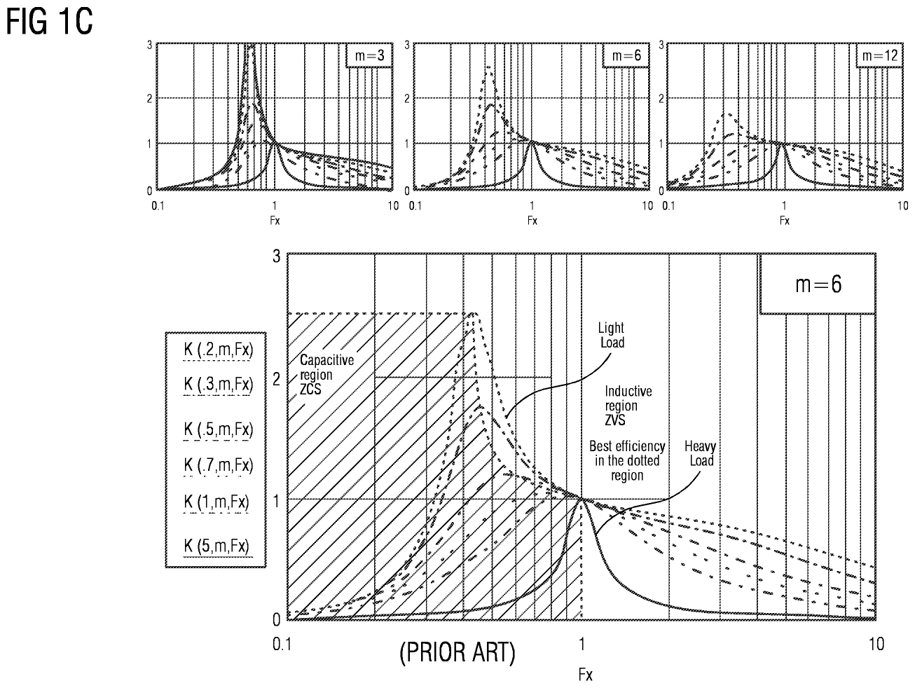

FIG. 1A illustrates a block diagram of a DC charger 100 employed in charging of EVs 106, according to state of the conventional art. The DC charger 100 includes a low voltage input module 101, a power electronics module 102 also referred to as a power converter 102, and an output module 103 electrically coupled to one another as shown in FIG. 1A. The low voltage input module has a 3-phase AC voltage supply Vac coming from the power grid 101A and an input side protection unit 101B. The power converter 102 has an input filter 102A, a 3-phase AC to DC converter 102B such as a 3-phase pulse width modulation (PWM) converter and an isolated DC-DC converter 102C, electrically coupled with one another. The output module 103 is an output protection unit that provides DC voltage at its output which is used by an EV 106 for DC fast charging. The DC charger 100 also includes a controller module 104, also referred to as the control unit 104, having one or more controllers 104A, 104B. The controller module 104 is electrically coupled with the power converter 102 for controlling the 3-phase pulse width modulation (PWM) converter 102B and the isolated DC-DC converter 102C.

The DC charger 100 also includes a software module 105 having a user interface 105A such as a human machine interface (HMI) electrically coupled with a communication controller module 105B which in turn communicates with portable electronic devices 105C such as cell phones, a cloud communication network 105D and/or the power grid 105E. The communication controller module 105B also communicates with the EV 106.

The DC output voltage being provided to the EV 106 should conform to the battery voltage rating of the EV 106 being charged. Usually, the battery capacity and voltage requirement of an EV 106 varies depending upon the EV range, that is, the distance which the EV 106 can cover in one full battery charge. For example, low range vehicles have a battery voltage of about 150V, whereas high range or heavy vehicles like E-trucks and E-Buses have a battery voltage of about 1500V. Therefore, for charging various types of EVs 106, the DC output voltage of the DC charger 100 should have a wide range from about 150V to about 1500V while ensuring delivery of high power over the whole range.

FIG. 1B illustrates an electrical circuit diagram of the power converter 102 of the DC charger 100 shown in FIG. 1A, according to state of the conventional art. The power converter 102 receives a 3-phase AC input Vac from the input module 101 which is then provided to its 3-phase AC to DC conversion module 102B which provides a DC output voltage Vin which in turn is provided as an input to the isolated DC-DC converter 102C.

Depending upon the power requirements, the isolated DC-DC converter 102C can either be a bi-directional converter or a unidirectional converter. As per recent trends for high power applications, for example, above 250 kW, unidirectional DC-DC converters are desired. This is primarily due to their low cost as compared to bi-directional converters. Also, a power converter with high power density is desired. One of the ways to achieve very high-power density is by operating the converters at high switching frequencies usually above 100 kHz. This reduces the size of magnetics and filtering components. However, for hard switched converters, switching losses are considerable when operated at such high switching frequencies. This impacts the overall converter efficiency. Therefore, the soft switching converters are suitable for such applications as they inherently have negligible switching loss. One such soft switching power converter with all the desirable features such as high efficiency, low EMI and high-power density is an LLC resonant converter 102C as shown in FIG. 1B.

However, for applications in EV charging, designing the LLC resonant converter 102C has several challenges and therefore, it is not the optimal solution from the point of view of cost, efficiency, and power density. To understand these challenges and the associated problems, it is important to understand the basic physics behind the working of LLC resonant converter 102C.

The LLC resonant converter 102C typically comprises two power conversion stages namely a first stage 201 performing DC to high frequency AC conversion via a primary full bridge rectifier and a second stage 202 performing high frequency AC to DC conversion via a secondary diode bridge rectifier. At the first stage 201, the DC voltage Vin is converted to a high frequency AC voltage of amplitude V1. At the second stage 202, a high frequency AC voltage of amplitude V2 is converted to the output DC voltage Vo. These two stages 201 and 202 are coupled by an intermediary stage 203 providing high frequency isolation therebetween and a resonant tank 204.

The intermediary stage 203 includes a high frequency transformer connected between the first stage 201 and the second stage 202 having a turns ratio of V1:V2.

The resonant tank 204 comprises a resonant inductor Lr, a resonant capacitor Cr and a transformer magnetizing inductor Lm connected to each other to form an LLC resonant tank as shown in FIG. 1B. The first stage 201 generates a square waveform to excite the LLC resonant tank 204, which will generate as an output, a resonant sinusoidal current that gets scaled by the transformer of the intermediary stage 203 and rectified by the rectifier diode bridge circuit of the second stage 202. An output capacitor C of the second stage 202 filters the rectified ac current and outputs a DC voltage Vo. Thus, the working principle of the LLC converter 102C is like an LC series resonant circuit wherein, due to zero impedance offered by an LC tank, peak gain of the LC tank is achieved at resonant frequency fr. However, due to the presence of Lm, the LLC resonant tank's switching frequency fs at peak resonance is now a function of load and lies somewhere in between frequencies fr and fp represented as below:

$${f}_{r} = \frac{1}{2 π \sqrt{{L}_{r} {C}_{r}}} ; {f}_{p} = \frac{1}{2 π \sqrt{( {L}_{r} + {L}_{m} ) {C}_{r}}}$$

However, to achieve zero cross over switching of the diode bridge rectifier in the second stage 202, the LLC resonant converter 102C should be operated below resonance, that is, switching frequency fs must be lower than fr.

The output voltage Vo is regulated by changing the switching frequency fs of the primary full bridge rectifier of the first stage 201 and thereafter changing the frequency of the square wave excitation to the LLC resonant tank 204. Converter gain of the LLC resonant converter 102C is a product of gain of the LLC resonant tank 204 and transformers turns ratio. The transformer turns ratio is a constant and cannot be changed physically. Thus, there is only one control variable which can be adjusted to obtain the required converter gain which is the resonant tank gain.

The output voltage Vo is therefore regulated via changing the gain of the LLC resonant tank 204. This gain is frequency dependent and can be represented as below:

$$K ( Q , m , {F}_{x} ) = \vert \frac{V \text{?} ( s )}{V \text{?} ( s )} \vert = \frac{{F}_{x}^{2} ( m - 1 )}{\sqrt{{( m \cdot {F}_{x}^{2} - 1 )}^{2} + {Fx}^{2} \cdot {( {F}_{x}^{2} - 1 )}^{2} \cdot {( m - 1 )}^{2} \cdot {Q}^{2}}}$$

$$\text{?} \text{indicates text missing or illegible when filed}$$

Wherein K is the gain of the LLC resonant tank 204 which is a function of a quality factor Q, a ratio m of total primary inductance to resonant inductance, and a normalized switching frequency Fx, each of whcih can be represented as below:

$$Q = [ \sqrt{\frac{Lr}{Cr} ]} / {R}_{a c}$$

and wherein R_{ac} is reflected laod resistance represented as below:

$${R}_{a c} = [ ( \frac{8}{{π}^{2}} ) ( \frac{{Np}^{2}}{{Ns}^{2}} ) {R}_{o} and$$

$${F}_{x} = \frac{{f}_{s}}{{f}_{r}}$$

Wherein fr is the resonant frequency represent as below:

fᵣ=1/(2π\sqrt{Lᵣ*Cᵣ})

and

m=(Lᵣ+Lₘ)/Lᵣ

From the above equations and from FIG. 1C illustrating various curves representing the parameters affecting the LLC resonant tank gain K, according to state of the conventional art, a person skilled in the conventional art, would appreciate that a higher gain K can be obtained at lighter load or at lower Q values; with the increasing value of m, the peak gain K that can be achieved goes on reducing; and when the LLC resonant tank 204 is operated below resonance, that is, when fs<fr, a boost mode, that is, K>1, is obtained, and when operated above resonance with fs>fr, a buck mode with K<1 is obtained. Moreover, to achieve zero voltage switching (ZVS) for the first stage 201, the LLC resonant converter 102C has to operate in the inductive region; and to achieve zero current switching (ZCS) of the second stage 202, the LLC resonant converter 102C has to operate with fs<fr, that is, in the boost mode. Furthermore, highest efficiency is achieved at resonance or very close to resonant frequency as the efficiency droops as we move farther away from the resonant frequency.

Therefore, in order to achieve both ZCS and ZVS, the LLC resonant converter 102C has to operate below resonance in boost mode and in the inductive region. Due to these restrictions, operation of the LLC resonant converter 102C is limited to the dotted region as shown in FIG. 1C, and the best efficiency for the LLC resonant converter 102C is achieved when operated in this narrow region. This leads to huge oversizing of several components when designing the LLC resonant converter 102C especially for a wide range of operation servicing the output voltage range of 150V to 1500V.

The aforementioned technical problem can be further elaborated using a design example, assuming a 25 kW LLC resonant converter 102C is being designed for an input voltage Vin=700V and a wide DC output voltage Vo ranging from about 250V to about 1000V. Thus, the design constranits are as below:
Desired power P=25 kW
Vin=700V
Vo_min=250V
Vo_max=1000V

For achieving ZCS the LLC resonant converter 102C must operate in boost mode. In boost mode, the minimum resonant tank gain of K=1 can be achieved at fs=fr.

Now Converter gain=Kmin*transformer turns ratio (Ns/Np)

Therefore, for K=1, Converter gain=transformer turns ratio, that is, Vo_min/Vin=transformer turns ratio

Therefore, transformer turns ratio=(Ns/Np)=250/700.

Thus, for an output voltage of 250V, the transformer primary voltage is 700V.

Now, for an output voltage of 1000V, the required gain is provided by resonant tank in the boost mode.
Therefore, Vomax/Vin=Kmax*(Ns/Np).
1000/700=Kmax*(250/700)
Kmax=1000/250=4.

Hence, we need a max boost gain of Kmax=4 in order to achieve max output voltage of 1000V.

Moreover, for an output of Vo_max=1000V, the transformer secondary voltage will be 1000V and therefore, primary voltage would be 700*4=2800V. This would increase the size and cost of the transformer in the intermediary stage 203 tremendously.

Furthermore, to achieve higher gain we have to operate farther away from resonance. Therefore, there is a drop in efficiency for the higher values of gain. This is due to the larger circulating magnetization current as we are now closer to fp and away from fr.

Furthermore, the resonant capacitor Cr has to be rated for a peak voltage of about 6000V and the resonant inductor Lr for a peak voltage rating of about 4000 C, thus, calling for huge sizes of both Lr and Cr.

Thus, it is evident that a practical design of an LLC resonant converter 102C over such a wide operating range of DC output voltqage with a high gain has several aforementioned problems making it non-feasible for practical implementations as such a conventional LLC resonant converter 102C can either provide a low cost and high power density or a wide output range but not both.

### SUMMARY

An aspect relates to a soft switching power converter that provides a wide range of DC output voltages having high power density without compromising on cost and without increasing number of components or size of components.

Moreover, it is another aspect of the present disclosure to provide a charging device, a control unit, and a method employing aforementioned soft switching power converter for transferring power to an electric vehicle from a power grid.

The power converter disclosed herein achieves the aforementioned object in that an isolated DC-DC converter of the power converter includes a second stage that is capable of selectively converting a high frequency AC voltage V2ac having an amplitude V2 into a DC voltage Vo of an amplitude V2 or 2V2, thereby selectively doubling an overall gain of the power converter.

According to one aspect of the present disclosure, the power converter disclosed herein comprises an AC-DC converter, for example, a 3 phase AC to DC converter generating a DC voltage Vin from an AC voltage Vacgrid received from an AC power grid. According to this aspect of the present disclosure, the power converter comprises an input filter filtering the AC voltage Vacgrid.

According to another aspect of the present disclosure, the power converter receives a DC voltage Vdcgrid from a DC power grid as the DC voltage Vin. The power converter comprises an isolated DC-DC converter. According to this aspect of the present disclosure, the DC voltage Vdcgrid is fed to the isolated DC-DC converter without requirement of an AC-DC conversion.

The isolated DC-DC converter comprises a first stage, a resonant tank, a second stage, and an intermediary stage electrically coupling the first stage and the resonant tank to the second stage.

The first stage converts the DC voltage Vin into a high frequency AC voltage V1ac, that is, at the first stage, a DC voltage Vin is converted to high frequency AC voltage of amplitude V1.

According to one aspect, the first stage comprises a capacitor connected across the output of the 3-phase AC-DC converter, across which the DC voltage V1 appears. The first stage also comprises four switches. The first stage comprises four power conversion switches S1-S4 electrically coupled to a primary winding A″-B″ of a high frequency transformer of the intermediary stage via the resonant tank such that a second terminal of a first power conversion switch S1 is connected to a first terminal of a second power conversion switch S2 and a first end A′ of a resonant inductor Lr of the resonant tank. A first terminal of the first power conversion switch S1 is connected to a first terminal of a third power conversion switch S3. A second terminal of the second power conversion switch S2 is connected to a second terminal of a fourth power conversion switch S4. A second terminal of the third power conversion switch S3 is connected to a first terminal of the fourth power conversion switch S4 and a first end B′ of a resonant capacitor Cr of the resonant tank.

The resonant tank is operably connected to the first stage and a primary winding A″-B″ of the high frequency transformer of the intermediary stage, wherein the resonant tank when excited by a square waveform generated by the first stage outputs a resonant sinusoidal current that is scaled by the high frequency transformer.

The resonant tank comprises a resonant inductor Lr, a resonant capacitor Cr, and a transformer magnetizing inductor Lm operably connected to one another such that a second end of the resonant inductor Lr is connected to a first end of the transformer magnetizing inductor Lm, wherein a first end A′ of the resonant inductor Lr is connected to a second terminal of a first power conversion switch S1 and a first terminal of a second power conversion switch S2 of the first stage, a second end of the resonant capacitor Cr is connected to a second end of the transformer magnetizing inductor Lm, wherein a first end B′ of the resonant capacitor Cr is connected to a second terminal of a third power conversion switch S3 and a first terminal of a fourth power conversion switch S4 of the first stage, and the first end of the transformer magnetizing inductor Lm is connected to a first end A″ of the primary winding A″-B″ of the high frequency transformer of the intermediary stage and a second end of the transformer magnetizing inductor Lm is connected to a second end B″ of the primary winding A″-B″ of the high frequency transformer.

The intermediary stage comprises a high frequency transformer having a turns ratio equal to a ratio of the high frequency AC voltage V1ac and the high frequency AC voltage V2ac, that is, V1:V2. V1 depends on the power grid supply voltage connection and V2 depends on a maximum voltage capacity of a vehicle battery. For example, V1 can range from about 300 to about 800V and V2 can range from about 400V to about 1500V.

According to one aspect, the high frequency transformer is a two-winding transformer, for example having a single primary winding and a single secondary winding. According to this aspect, the high frequency AC voltage V1ac is applied to the primary winding and the high frequency AC voltage V2ac is applied to the secondary winding. According to another aspect, the high frequency transformer is a multi-winding transformer, for example having multiple windings at the primary side and multiple windings at the secondary side. According to this aspect, the high frequency AC voltage V1ac is applied to one of the windings at the primary side and the high frequency AC voltage V2ac is applied to a set of multiple windings on the secondary side. According to this aspect, multiple second stages, that is, one per winding at the secondary side, are connected in parallel.

The second stage converts a high frequency AC voltage V2ac having an amplitude V2 into the DC voltage Vo. The DC voltage Vo is equal to V2 or 2V2, thereby, providing for a wider range of DC voltage.

The second stage comprises a power conversion switch S5 having a diode D5 connected in parallel across the power conversion switch S5. Each power conversion switch used in the first stage as well as the second stage is a two-quadrant switch. As used herein, the term “switch” refers to a switching device capable of connecting and disconnecting two electrical nodes realized, for example, using an Insulated-Gate Bipolar Transistor (IGBT), a Metal-Oxide-Semiconductor Field-Effect Transistor (MOSFET), thyristors, diodes, variable resistances or using any other devices of this class apparent to a person skilled in the conventional art. The switch may also be a mechanical switch such as a contactor. Each of the power conversion switches of the first stage and/or the second stage may be realized using a series or a parallel connection of one or more individual switches with help of a common gating logic pulse that would meet the voltage and current requirements of the power converter.

Each of the power conversion switches S1-S5 of the first stage and the second stage, when in an off state, blocks a positive DC voltage Vo applied across the first terminal and the second terminal of each of the power conversion switches S1-S5.

The second stage also comprises two or more capacitors, for example, C1 and C2, electrically coupled with the power conversion switch such that each of the capacitors is equally charged during operation of the power converter.

The second stage also comprises four diodes D1-D4 electrically coupled to the power conversion switch S5 and the capacitors C1, C2, so as to form a variable gain rectifier at the second stage. The variable gain rectifier selectively generates a gain of 1 or 2 based on the position of the power conversion switch S5. For example, the power conversion switch S5 when in a closed state enables the second stage to generate the DC voltage Vo having the amplitude 2V2 corresponding to the high frequency AC voltage V2ac of the amplitude V2 and the power conversion switch S5 when in an open state enables the second stage to generate the DC voltage Vo having the amplitude V2 corresponding to the high frequency AC voltage V2ac having the amplitude V2.

For example, when the power conversion switch S5 is closed, that is, in an ON state, the DC voltage Vo equals 2V2 thus generating a gain of 2. Similarly, when the power conversion switch S5 is open, that is, in an OFF state, the DC voltage Vo equals V2 thus generating a gain of 1.

According to one aspect, in the second stage, the power conversion switch S5, the four diodes D1-D4, and the capacitors C1 and/or C2 are arranged across a secondary winding A-B of the high frequency transformer such that a first terminal of a first diode D1 is connected to a second terminal of a second diode D2 and a first end A of the secondary winding. A first terminal of the second diode D2 is connected to a first terminal of a fourth diode D4 and a negative terminal of a second capacitor C2. A second terminal of the fourth diode D4 is connected to a second terminal of the power conversion switch S5 and a second end B of the secondary winding. A first terminal of the power conversion switch S5 is connected to a first terminal of a third diode D3, a positive terminal of the second capacitor C2 and a negative terminal of a first capacitor C1, and a second terminal of the first diode D1 is connected to a second terminal of the third diode D3 and to a positive terminal of the first capacitor C1.

According to another aspect, in the second stage, the power conversion switch S5, the four diodes D1-D4, and the capacitors C1 and/or C2 are arranged across a secondary winding A-B of the high frequency transformer such that a first terminal of a first diode DI is connected to a second terminal of a second diode D2 and a first end A of the secondary winding A-B, a first terminal of the second diode D2 is connected to a first terminal of a fourth diode D4 and a negative terminal of a second capacitor C2, a second terminal of the fourth diode D4 is connected to a second terminal of the power conversion switch S5, a positive terminal of the second capacitor C2 and a negative terminal of a first capacitor C1, a first terminal of the power conversion switch S5 is connected to a first terminal of a third diode D3 and a second end B of the secondary winding A-B, and a second terminal of the first diode D1 is connected to a second terminal of the third diode D3 and to a positive terminal of the first capacitor C1.

It would be understood to a person skilled in the conventional art that multiple such power converters may be connected together and employed as a multiphase converter with multiphase input and/or output connections. Moreover, each single-phase converter can have multiple input connections connected together in parallel.

Also, disclosed herein is a control unit controlling the aforementioned power converter and more specifically the isolated DC-DC converter of the power converter. The control unit comprises controller(s) that selectively switch the power conversion switch S5 of the second stage of the isolated DC-DC converter of the power converter, between a closed state, that is an ON state, and an open state, that is an OFF state, based on a voltage requirement of a battery of an electric vehicle when connected to a vehicle-side module connectable to the power converter.

Also, disclosed herein is a charging device for transferring power to an electric vehicle (EV) from a power grid. The charging device comprises the aforementioned control unit, the aforementioned power converter being controlled by the control unit, a grid-side module, and a vehicle-side module.

The grid-side module is capable of receiving an AC voltage Vacgrid or a DC voltage Vdcgrid from the power grid, for example, an AC power grid or a DC power grid and/or an energy storage system respectively.

The vehicle-side module is capable of delivering a DC voltage Vo to the EV connected to the charging device, for charging the EV.

The charging device disclosed herein, is a DC fast charger capable of charging a wide range of EVs including, for example, light motor vehicles such as cars and heavy duty EVs such as trucks, buses, etc.

Also, disclosed herein is a method for transferring power to an electric vehicle (EV) from a power grid using the aforementioned charging device. In embodiments, the method detects physical connection of the EV to the vehicle-side module of the charging device. In embodiments, the method selectively operates, based on a voltage requirement of a battery of the EV, the power conversion switch S5 of the second stage of the isolated DC-DC converter of the power converter of the charging device in one of a closed state and an open state. The power conversion switch S5 when in the closed state enables the second stage to generate the DC voltage Vo having an amplitude 2V2 corresponding to a high frequency AC voltage V2ac of the amplitude V2, and when in an open state enables the second stage to generate the DC voltage Vo having an amplitude V2 corresponding to the high frequency AC voltage V2ac having the amplitude V2.

In embodiments, the method switches the power conversion switch S5, for example, by employing a control unit of the charging device, between the states closed and open, depending upon the type of the EV to which the DC voltage Vo is to be applied and voltage requirements of the battery of this EV.

In embodiments, the method employs the charging device to detect the voltage requirement of the EV using the control unit which in turn is electrically coupled with the power converter. Alternatively, the method detects the voltage requirement of the EV by the software module, which in turn is electrically coupled with the control unit. The software module, for example, via its user interface receives the voltage requirement as a user input. Alternatively, the method employs one or more image capturing devices in communication with the software module to record one or more images of the EV which are in turn processed by the software module to determine a make and a type of the EV based on which the voltage requirement is determined.

In embodiments, the method switches the power conversion switch S5 ON by closing it, when the EV is a heavy-duty vehicle such as a bus or a truck, to generate Vo=2V2.

In embodiments, the method switches the power conversion switch S5 OFF by opening it, when the EV is not a heavy-duty vehicle such as a light motor vehicle, etc., to generate Vo=V2.

In embodiments, the method further includes providing the DC voltage Vo to the EV via the vehicle-side module of the charging device for charging the EV.

The above mentioned and other features of embodiments of the invention will now be addressed with reference to the accompanying drawings of embodiments of the present invention. The illustrated embodiments are intended to illustrate, but not limit the invention.

### BRIEF DESCRIPTION

Some of the embodiments will be described in detail, with reference to the following figures, wherein like designations denote like members, wherein:

FIG. 1A illustrates a block diagram of a DC charger employed in charging of Electric Vehicles (EVs), according to state of the conventional art;

FIG. 1B illustrates an electrical circuit diagram of the power converter of the DC charger shown in FIG. 1A, according to state of the conventional art;

FIG. 1C illustrates various curves representing parameters affecting gain ‘K’ of an LLC resonant tank of an isolated DC-DC converter of the power converter shown in FIG. 1B, according to state of the conventional art;

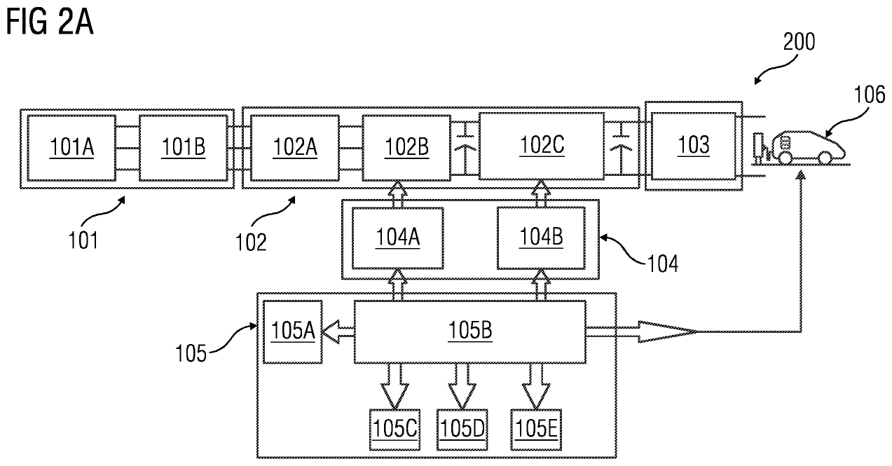

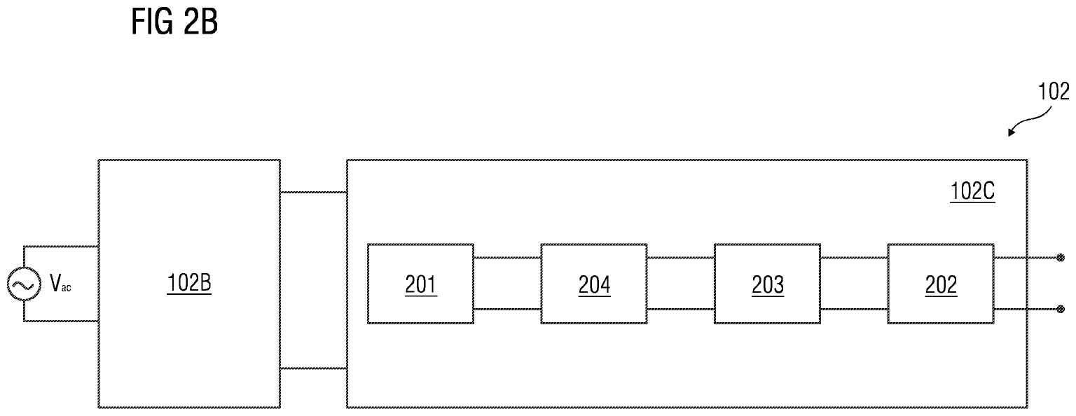

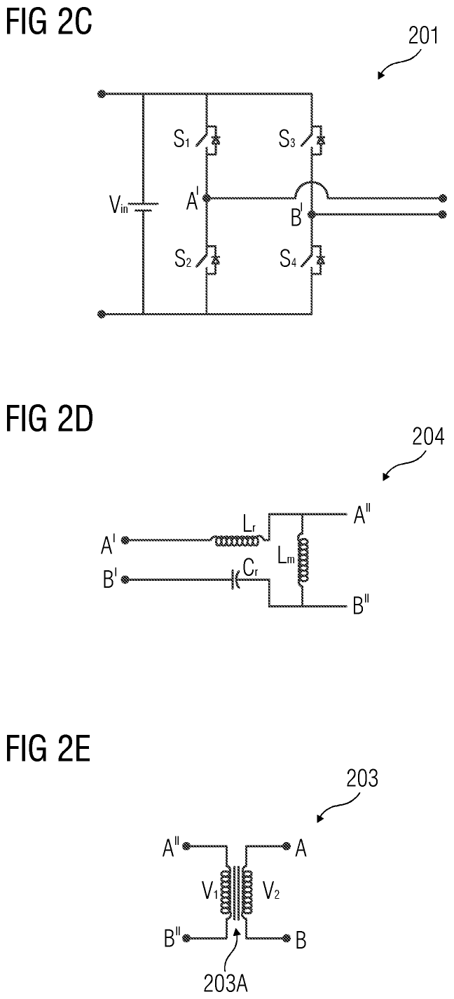

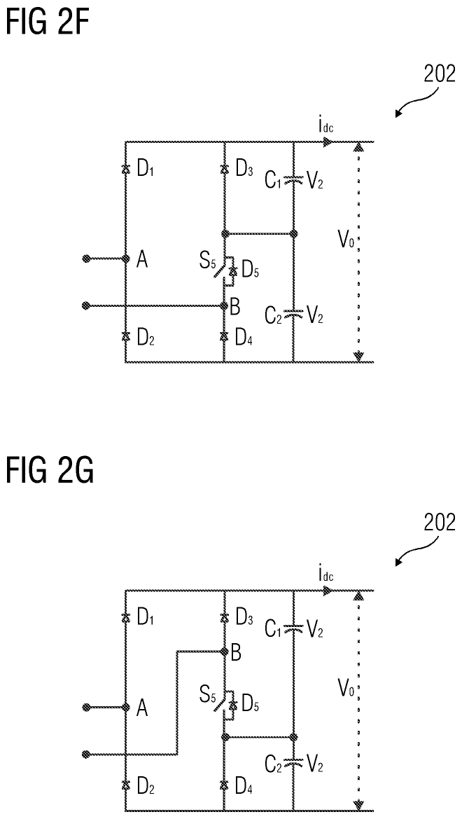

FIG. 2A illustrates a block diagram of a charging device employed in charging of Electric Vehicles (EVs), according to an embodiment of the present disclosure;

FIG. 2B illustrates a block diagram of a power converter of the charging device shown in FIG. 2A, according to an embodiment of the present disclosure;

FIG. 2C illustrates an electrical circuit diagram of a first stage of the isolated DC-DC converter shown in FIG. 2B, according to an embodiment of the present disclosure;

FIG. 2D illustrates an electrical circuit diagram of a resonant tank of the isolated DC-DC converter shown in FIG. 2B, according to an embodiment of the present disclosure;

FIG. 2E illustrates an electrical circuit diagram of an intermediary stage of the isolated DC-DC converter shown in FIG. 2B, according to an embodiment of the present disclosure;

FIG. 2F illustrates an electrical circuit diagram of a second stage of the isolated DC-DC converter shown in FIG. 2B, according to various embodiments of the present disclosure;

FIG. 2G illustrates an electrical circuit diagram of a second stage of the isolated DC-DC converter shown in FIG. 2B, according to various embodiments of the present disclosure;

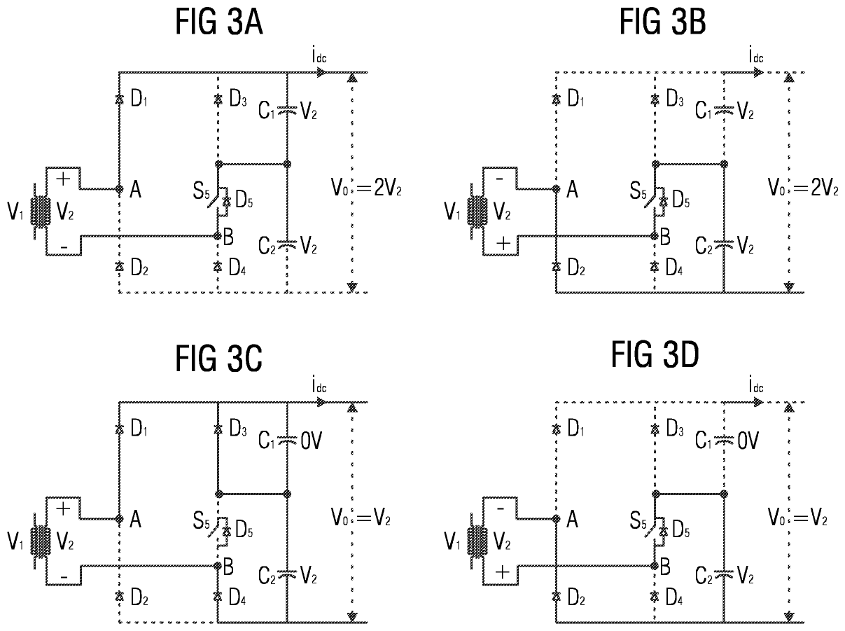

FIG. 3A illustrates a current flow through the electrical circuit diagram of the second stage of the isolated DC-DC converter, shown in FIG. 2F, when a power conversion switch of the second stage is closed, according to an embodiment of the present disclosure;

FIG. 3B illustrates a current flow through the electrical circuit diagram of the second stage of the isolated DC-DC converter, shown in FIG. 2F, when a power conversion switch of the second stage is closed, according to an embodiment of the present disclosure;

FIG. 3C illustrates a current flow through the electrical circuit diagram of the second stage of the isolated DC-DC converter, shown in FIG. 2F, when a power conversion switch of the second stage is open, according to an embodiment of the present disclosure;

FIG. 3D illustrates a current flow through the electrical circuit diagram of the second stage of the isolated DC-DC converter, shown in FIG. 2F, when a power conversion switch of the second stage is open, according to an embodiment of the present disclosure; and

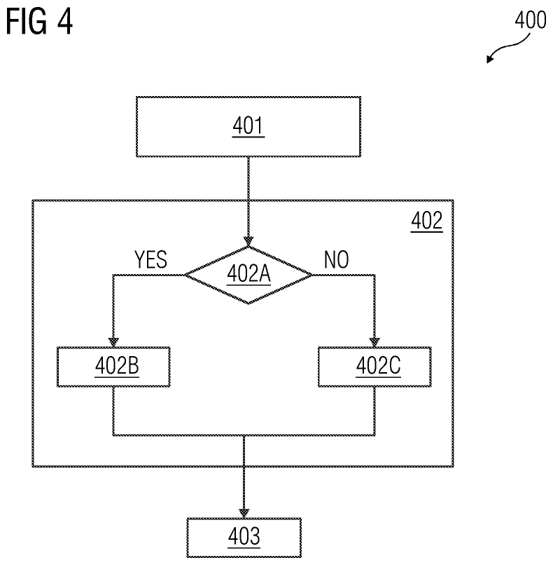

FIG. 4 illustrates a process flow chart of a method for transferring power to an electric vehicle from a power grid employing the charging device shown in FIG. 2A, according to an embodiment of the present disclosure.

### DETAILED DESCRIPTION

Various embodiments are described with reference to the drawings, wherein like reference numerals are used to refer like elements throughout. In the following description, for the purpose of explanation, numerous specific details are set forth in order to provide thorough understanding of one or more embodiments. It may be evident that such embodiments may be practiced without these specific details.

FIG. 2A illustrates a block diagram of a charging device 200 employed in charging of Electric Vehicles (EVs) 106, according to an embodiment of the present disclosure. The charging device 200 includes a grid-side module 101, a power converter 102, and a vehicle-side module 103 electrically coupled to one another as shown in FIG. 2A. The grid-side module 101 has a 3-phase AC voltage supply Vacgrid represented by 101A coming from the power grid and a protection unit 101B electrically coupled to the 3-phase AC voltage supply 101A. The grid-side module 101 acts as an interface between the power converter 102 and the power grid for receiving AC voltage Vacgrid from the power grid.

The power converter 102 has an input filter 102A, a 3-phase AC to DC converter 102B such as a 3-phase pulse width modulation (PWM) converter and an isolated DC-DC converter 102C, electrically coupled with one another. The vehicle-side module 103 is a protection unit that is capable of delivering a DC voltage Vo to an EV 106. The charging device 200 also includes a control unit 104 having one or more controllers 104A, 104B. The control unit 104 is electrically coupled with the power converter 102 for controlling the 3-phase pule width modulation (PWM) converter 102B and the isolated DC-DC converter 102C.

The charging device 102 also includes a software module 105 having a user interface 105A such as a human machine interface (HMI) electrically coupled with a communication controller module 105B which in turn communicates with portable electronic devices 105C such as cell phones, a cloud communication network 105D and/or the power grid 105E. The communication controller module 105B also communicates with the EV 106.

FIG. 2B illustrates a block diagram of a power converter 102 of the charging device 200 shown in FIG. 2A, according to an embodiment of the present disclosure. The power converter 102 receives a 3-phase AC input Vacgrid from the grid-side module 101 which is then provided to a 3-phase AC to DC converter 102B of the power converter 102, that generates a DC voltage Vin which in turn is provided as an input to the isolated DC-DC converter 102C.

The isolated DC-DC converter 102C comprises a first stage 201 capable of converting the DC voltage Vin into a high frequency AC voltage Vlac of amplitude V1. The isolated DC-DC converter 102C comprises a second stage 202. The second stage 202 is capable of converting a high frequency AC voltage V2ac of amplitude V2 into DC voltage Vo of amplitude V2 or 2V2 selectively. These two stages, that is, the first stage 201 and the second stage 202 are coupled by an intermediary stage 203 providing high frequency isolation therebetween and a resonant tank 204. The resonant tank 204, when excited by a square waveform generated by the first stage 201, generates a resonant sinusoidal current which gets scaled by the intermediary stage 203 and rectified by the second stage 202. The second stage 202 also filters the rectified ac current and outputs a DC voltage Vo.

FIG. 2C illustrates an electrical circuit diagram of a first stage 201 of the isolated DC-DC converter 102C shown in FIG. 2B, according to an embodiment of the present disclosure. The first stage forms a primary full bridge rectifier and includes four power conversion switches S1-S4 electrically coupled to the resonant tank 204 such that a second terminal of a first power conversion switch S1 is connected to a first terminal of a second power conversion switch S2 and a first end A′ of a resonant inductor Lr of the resonant tank 204. A first terminal of the first power conversion switch S1 is connected to a first terminal of a third power conversion switch S3. A second terminal of the second power conversion switch S2 is connected to a second terminal of a fourth power conversion switch S4. A second terminal of the third power conversion switch S3 is connected to a first terminal of the fourth power conversion switch S4 and a first end B′ of a resonant capacitor Cr of the resonant tank 204.

As shown in FIG. 2C, each of the power conversion switches S1-S4 when in an off state, blocks a positive DC voltage applied across the first terminal and the second terminal of each of the power conversion switches S1-S4. This is achieved via a diode connected in parallel to each power conversion switch S1-S4.

FIG. 2D illustrates an electrical circuit diagram of a resonant tank 204 of the isolated DC-DC converter 102C shown in FIG. 2B, according to an embodiment of the present disclosure. The resonant tank includes a resonant inductor Lr, a resonant capacitor Cr, and a transformer magnetizing inductor Lm operably connected to one another.

A second end of the resonant inductor Lr is connected to a first end of the transformer magnetizing inductor Lm. As disclosed in the detailed description of FIG. 2C, a first end A′ of the resonant inductor Lr is connected to a second terminal of a first power conversion switch S1 and a first terminal of a second power conversion switch S2 of the first stage 201.

A second end of the resonant capacitor Cr is connected to a second end of the transformer magnetizing inductor Lm. Also, as disclosed in the detailed description of FIG. 2C, a first end B′ of the resonant capacitor Cr is connected to a second terminal of a third power conversion switch S3 and a first terminal of a fourth power conversion switch S4 of the first stage 201. The transformer magnetizing inductor Lm is connected across the intermediary stage 203.

FIG. 2E illustrates an electrical circuit diagram of an intermediary stage 203 of the isolated DC-DC converter 102C shown in FIG. 2B, according to an embodiment of the present disclosure. The intermediary stage 203 includes a high frequency transformer 203A connected between the the resonant tank 204 connected to the first stage 201, and the second stage 202. The high frequncy transformer 203A has a primary winding A″-B″ and a secondary winding A-B having a turns ratio of V1:V2 therebwtween. The first end of the transformer magnetizing inductor Lm of the resonant tank 204 is connected to a first end A″ of the primary winding of the high frequency transformer 203A of the intermediary stage 203 and a second end of the transformer magnetizing inductor Lm is connected to a second end B″ of the primary winding of the high frequency transformer 203A.

FIGS. 2F-2G illustrate an electrical circuit diagram of a second stage 202 of the isolated DC-DC converter 102C shown in FIG. 2B, according to various embodiments of the present disclosure. The second stage 202 includes a power conversion switch S5, four diodes D1-D4, and the two or more capacitors C1, C2 are arranged across a secondary winding A-B of the high frequency transformer 203A of the intermediary stage.

According to an embodiment shown in FIG. 2F, a first terminal of a first diode D1 is connected to a second terminal of a second diode D2 and a first end A of the secondary winding. A first terminal of the second diode D2 is connected to a first terminal of a fourth diode D4 and a negative terminal of a second capacitor C2. A second terminal of the fourth diode D4 is connected to a second terminal of the power conversion switch S5 and a second end B of the secondary winding. A first terminal of the power conversion switch S5 is connected to a first terminal of a third diode D3, a positive terminal of the second capacitor C2 and a negative terminal of a first capacitor C1. A second terminal of the first diode D1 is connected to a second terminal of the third diode D3 and to a positive terminal of the first capacitor C1.

According to another embodiment shown in FIG. 2G, a first terminal of a first diode D1 is connected to a second terminal of a second diode D2 and a first end A of the secondary winding. A first terminal of the second diode D2 is connected to a first terminal of a fourth diode D4 and a negative terminal of a second capacitor C2. A second terminal of the fourth diode D4 is connected to a second terminal of the power conversion switch S5, a positive terminal of the second capacitor C2 and a negative terminal of a first capacitor C1. A first terminal of the power conversion switch S5 is connected to a first terminal of a third diode D3 and a second end B of the secondary winding. A second terminal of the first diode D1 is connected to a second terminal of the third diode D3 and to a positive terminal of the first capacitor C1.

As shown in both FIGS. 2F and 2G, the power conversion switch S5 when in an off state, blocks a positive DC voltage applied across its first terminal and second terminal. This is achieved by connecting a diode D5 across the power conversion switch S5.

The operation, that is, switching on and off, of the power conversion switch S5 determines whether the DC voltage Vo, appearing across the second stage 202, that is, capacitors C1 and C2, is V2 or 2V2.

FIGS. 3A-3B illustrate current flows through the electrical circuit diagram of the second stage 202 of the isolated DC-DC converter 102C, shown in FIG. 2F, when a power conversion switch S5 of the second stage 202 is closed, according to an embodiment of the present disclosure.

The voltage appearing at the secondary winding A-B of the high frequency transformer 203A is an alternating voltage V_{AB}. As shown in FIG. 3A, when V_{AB} is positive, the first diode D1 is forward biased, thereby charging the first capacitor C1 to voltage V2 via the closed power conversion switch S5.

As shown in FIG. 3B, when V_{AB} is negative, the second diode D2 and the diode D5 connected across the power conversion switch S5 are forward biased, thus charging the second capacitor C2 to voltage V2 via the closed power conversion switch S5.

As the high frequency voltage V_{AB} at the secondary winding A-B is positive and negative for equal periods, both the capacitors C1 and C2 are charged equally to the voltage V2, wherein V2 is the amplitude of the high frequency voltage V2ac or V_{AB}. The output voltage Vo is the sum of the voltages across the capacitors C1 and C2 which is 2V2. Thus, the output of the second stage 202 and therefore the power converter 102 is 2V2.

Also, as disclosed above, the gain of the second stage 202 now becomes 2. Therefore, when the power conversion S5 is closed, and the gain is 2, overall gain ‘G’ of the power converter 102 can be represented as:

$$G = 2 * K * ( \frac{Ns}{Np} )$$

Wherein K is gain of the resonant tank 204 and
Ns/Np is the transformer turns ratio.

Thus, the overall gain of the power converter now becomes twice that of the power converter according to state of the conventional art disclosed in the detailed description of FIG. 1B.

FIGS. 3C-3D illustrate current flows through the electrical circuit diagram of the second stage 202 of the isolated DC-DC converter 102C, shown in FIG. 2F, when a power conversion switch S5 of the second stage 202 is open, according to an embodiment of the present disclosure.

As shown in FIG. 3D, when V_{AB} is negative, the second diode D2 and the diode D5 connected across the power conversion switch S5 are forward biased, thus the second capacitor C2 is charged to a voltage V2 via the diodes D2 and D4. However, as shown in FIG. 3C, when V_{AB} is positive, the first diode D1 and the fourth diode D4 are forward biased. Thus, both the capacitors C1 and C2 are charged via the diodes D1 and D4.

As the high frequency voltage V2ac or V_{AB} at the secondary A-B is positive and negative for equal periods, the capacitor C2 is charged for both negative as well as the positive half cycle of the voltage V_{AB}. Whereas the capacitor C1 is charged only in the positive half cycle. This asymmetry leads to the charge imbalance across the capacitors C1 and C2.

As both the capacitors C1 and C2 discharge into the load, this imbalance causes the voltage across the first capacitor C1 to drop till the moment when the voltage across the first capacitor C1 turns negative. As this voltage across the first capacitor C1 turns just about negative, the third diode D3 gets forward biased. Thus, the voltage across the first capacitor C1 is forward voltage of the diode D3. This is negligible as compared to the output voltage Vo and therefore considered to be zero. Thus, the voltage across the first capacitor C1 is zero and across the second capacitor C2 is V2.

As the output voltage Vo is the sum of the voltages across C1 and C2 which is V2, thus making the gain of the second stage 202 now 1. When the power conversion switch S5 is open, the gain thus becomes 1.

Hence, it is evident that by changing the state of the power conversion switch S5 we can either have output voltage Vo equal to V2 for lower voltage requirements or 2V2 for higher voltage requirements.

Moreover, the power conversion switch S5 need not be a high frequency electronic switch. It can either be a mechanical switch like a relay or a contactor or a thyristor, MOSFET, IGBT or any other device of these class. Whichever solution is a cheaper can be considered while selecting the power conversion switch S5. Moreover, the amplitude of the voltage V2 can be regulated by adjusting gain of the resonant tank 204 via switching frequency modulation. Thus, depending on the type of the EV 106 connected to the charging device 200, the state of the power conversion switch S5 is varied selectively to achieve almost double the output voltage Vo as compared to the power converter of state of the conventional art, thereby ensuring wide output voltage range capability.

FIG. 4 illustrates a process flow chart 400 of a method for transferring power to an electric vehicle (EV) 106 from a power grid employing the charging device 200 shown in FIG. 2A, according to an embodiment of the present disclosure.

At step 401, the method detects physical connection of the EV 106 to the vehicle-side module 103 of the charging device 200.

At step 402, the method selectively operates, based on a voltage requirement of a battery of the EV 106, the power conversion switch S5 of the second stage 202 of the isolated DC-DC converter 102C of the power converter 102 of the charging device 200 in one of a closed state and an open state. The power conversion switch S5 when in the closed state enables the second stage 202 to generate the DC voltage Vo having an amplitude 2V2 corresponding to a high frequency AC voltage V2ac of the amplitude V2, and when in an open state enables the second stage 202 to generate the DC voltage Vo having an amplitude V2 corresponding to the high frequency AC voltage V2ac having the amplitude V2.

In embodiments, the method switches the power conversion switch S5, for example, by employing a control unit 104 of the charging device 200, between the states closed and open, depending upon the type of the EV 106 to which the DC voltage Vo is to be applied and voltage requirements of the battery of this EV 106.

At step 402A, the method employs the charging device 200 to detect the voltage requirement of the EV 106 using the control unit 104 shown in FIG. 2A, which in turn is electrically coupled with the power converter 102. Alternatively, the method detects the voltage requirement of the EV 106 by the software module 105, which in turn is electrically coupled with the control unit 104. The software module 105, for example, via its user interface 105A receives the voltage requirement as a user input. Alternatively, the method employs one or more image capturing devices (not shown) in communication with the software module 105 to record one or more images of the EV 106 which are in turn processed by the software module 105 to determine a make and a type of the EV 106 based on which the voltage requirement is determined.

At step 402B, the method switches the power conversion switch S5 on by closing it, when the EV 106 is a heavy-duty vehicle such as a bus or a truck, to generate Vo=2V2.

At step 402C, the method switches the power conversion switch S5 OFF by opening it, when the EV 106 is not a heavy-duty vehicle such as a light motor vehicle, etc., to generate Vo=V2.

At step 403, the method further includes providing the DC voltage Vo to the EV 106 via the vehicle-side module 103 of the charging device 200 for charging the EV 106.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A power converter, comprising:
an isolated DC-DC converter comprising:
a first stage capable of converting a DC voltage into a first high frequency AC voltage having an amplitude V1;
an intermediary stage having a high frequency transformer, wherein a turns ratio of the high frequency transformer equals a ratio of the high frequency AC voltage and a second high frequency AC voltage;
a resonant tank operably connected to the first stage and a primary winding of the high frequency transformer of the intermediary stage, wherein the resonant tank when excited by a square waveform generated by the first stage outputs a resonant sinusoidal current that is scaled by the high frequency transformer; and
a second stage, electrically coupled to a secondary winding of the high frequency transformer of the intermediary stage, comprising a power conversion switch, four diodes, and two or more capacitors, electrically coupled to one another, wherein the second stage selectively converts the second high frequency AC voltage of an amplitude V2 into a DC voltage of amplitude equaling one of V2 and 2V2.

2. The power converter according to claim 1, wherein the first stage comprises four power conversion switches electrically coupled to the resonant tank such that:
a second terminal of a first power conversion switch is connected to a first terminal of a second power conversion switch and a first end of a resonant inductor of the resonant tank;
a first terminal of the first power conversion switch is connected to a first terminal of a third power conversion switch, and a second terminal of the second power conversion switch is connected to a second terminal of a fourth power conversion switch; and
a second terminal of the third power conversion switch is connected to a first terminal of the fourth power conversion switch, and a first end of a resonant capacitor of the resonant tank.

3. The power converter according to claim 1, wherein the resonant tank comprises a resonant inductor, a resonant capacitor, and a transformer magnetizing inductor operably connected to one another such that:
a second end of the resonant inductor is connected to a first end of the transformer magnetizing inductor, wherein a first end of the resonant inductor is connected to a second terminal of a first power conversion switch and a first terminal of a second power conversion switch of the first stage;
a second end of the resonant capacitor is connected to a second end of the transformer magnetizing inductor, wherein a first end of the resonant capacitor is connected to a second terminal of a third power conversion switch and a first terminal of a fourth power conversion switch of the first stage; and
the first end of the transformer magnetizing inductor is connected to a first end of the primary winding of the high frequency transformer of the intermediary stage and a second end of the transformer magnetizing inductor is connected to a second end of the primary winding of the high frequency transformer.

4. The power converter according to claim 1, wherein in the second stage, the power conversion switch, the four diodes, and the two or more capacitors are arranged across a secondary winding of the high frequency transformer such that:
a first terminal of a first diode is connected to a second terminal of a second diode and a first end of the secondary winding;
a first terminal of the second diode is connected to a first terminal of a fourth diode and a negative terminal of a second capacitor;
a second terminal of the fourth diode is connected to a second terminal of the power conversion switch and a second end of the secondary winding;
a first terminal of the power conversion switch is connected to a first terminal of a third diode, a positive terminal of the second capacitor and a negative terminal of a first capacitor; and
a second terminal of the first diode is connected to a second terminal of the third diode (D3) and to a positive terminal of the first capacitor.

5. The power converter according to claim 1, wherein in the second stage, the power conversion switch, the four diodes, and the two or more capacitors are arranged across a secondary winding of the high frequency transformer such that:
a first terminal of a first diode is connected to a second terminal of a second diode and a first end of the secondary winding;
a first terminal of the second diode is connected to a first terminal of a fourth diode and a negative terminal of a second capacitor;
a second terminal of the fourth diode is connected to a second terminal of the power conversion switch, a positive terminal of the second capacitor and a negative terminal of a first capacitor;
a first terminal of the power conversion switch is connected to a first terminal of a third diode and a second end of the secondary winding; and
a second terminal of the first diode is connected to a second terminal of the third diode and to a positive terminal of the first capacitor.

6. The power converter according to claim 1, wherein each of the power conversion switches, when in an off state, blocks a positive DC voltage applied across the first terminal and the second terminal of each of the power conversion switches.

7. The power converter according to claim 1, wherein:
the power conversion switch when in a closed state enables the second stage to generate the DC voltage having the amplitude 2V2 corresponding to the second high frequency AC voltage of the amplitude V2; and
the power conversion switch when in an open state enables the second stage to generate the DC voltage having the amplitude V2 corresponding to the second high frequency AC voltage having the amplitude V2.

8. A control unit controlling the power converter according to claim 1, wherein the control unit comprises one or more controllers configured to selectively switch a power conversion switch, of a second stage of an isolated DC-DC converter of the power converter, between a closed state and an open state based on a voltage requirement of a battery of an electric vehicle when connected to a vehicle-side module connectable to the power converter.

9. A charging device for transferring power to an electric vehicle from a power grid, wherein the charging device comprises:
the control unit according to claim 8;
the power converter, being controlled by the control unit;
a grid-side module capable of receiving one of an AC voltage and a DC voltage from the power grid
a vehicle-side module capable of delivering the DC voltage to the electric vehicle,
and wherein the vehicle-side module is electrically coupled to the grid-side module via the power converter.

10. A method for transferring power to an electric vehicle from a power grid using the charging device according to claim 9, comprising:
detecting physical connection of the electric vehicle to the vehicle-side module of the charging device; and
selectively operating, based on a voltage requirement of a battery of the electric vehicle, a power conversion switch of the second stage of the isolated DC-DC converter of the power converter of the charging device in one of a closed state and an open state.

11. The method according to claim 9, wherein the power conversion switch when in the closed state enables the second stage to generate the DC voltage having an amplitude 2V2 corresponding to a high frequency AC voltage of the amplitude V2, and when in an open state enables the second stage to generate the DC voltage having an amplitude V2 corresponding to the high frequency AC voltage having the amplitude V2.
